(19) United States
(12) Patent Application Publication
(10) Pub. No.: US 2011/0314370 A1
(43) Pub. Date: Dec. 22, 2011

(54) TIERED PAGEVIEW GENERATION FOR COMPUTING DEVICES

(75) Inventors: Christopher Evans, Sammamish, WA (US); Chad Neff, Everett, WA (US); Scott Jensen, Shoreline, WA (US); Shawn Murphy, Seattle, WA (US); Advay V. Mengle, Bellevue, WA (US); Jeffrey T. Pearce, Seattle, WA (US); Michael Antonio, Seattle, WA (US)

(73) Assignee: MICROSOFT CORPORATION, Redmond, WA (US)

(21) Appl. No.: 12/819,021

(22) Filed: Jun. 18, 2010

(51) Int. Cl. G06F 3/14

(52) U.S. Cl. 715/234

(57) ABSTRACT

A page controller module is provided for generating a pageview on a computing device according to a page definition that identifies a plurality of blocks corresponding to the pageview. In response to the page definition, and for each of the plurality of blocks, the page controller module initializes a block controller module for the block, which issues data requests to receive values for parameters associated with the block. Further, view modules are provided for rendering the viewable portion of the page using the values received in response to data requests from the block controller module. In some embodiments, block controllers may register data requests with the page controller so that the page controller may manage fulfillment of the data requests. The page controller may manage fulfillment by scheduling registered data requests and/or by reducing redundancies in registered data requests.

### BACKGROUND

Managing and updating pages for viewing on computing devices can be difficult. Page sources include logic that controls how the page operates and code that controls how the page appears to viewers. Integration of page logic and code can make modification of the page difficult, breaking page function and leading to incongruous visual appearance with other pages. As a result, page developers may need to sort through extensive code when making a change to the appearance, delaying roll-out of page appearance upgrades and delaying the introduction of new page features.

### SUMMARY

A page controller module is provided for generating a pageview on a computing device according to a page definition that identifies a plurality of blocks corresponding to the pageview. In response to the page definition, and for each of the plurality of blocks, the page controller module initializes a block controller module for the block, which issues data requests to receive values for parameters associated with the block. Further, view modules are provided for rendering the viewable portion of the page using the values received in response to data requests from the block controller module. In some embodiments, block controllers may register data requests with the page controller so that the page controller may manage fulfillment of the data requests. The page controller may manage fulfillment by scheduling registered data requests and/or by reducing redundancies in registered data requests.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a page for viewing on a computing device according to an embodiment of the present disclosure.

FIG. 2 shows a pageview generating system according to an embodiment of the present disclosure.

FIG. 3 shows a page definition according to an embodiment of the present disclosure.

FIG. 4 shows a flow chart of a method for generating pages for viewing on a computing device according to an embodiment of the present disclosure.

### DETAILED DESCRIPTION

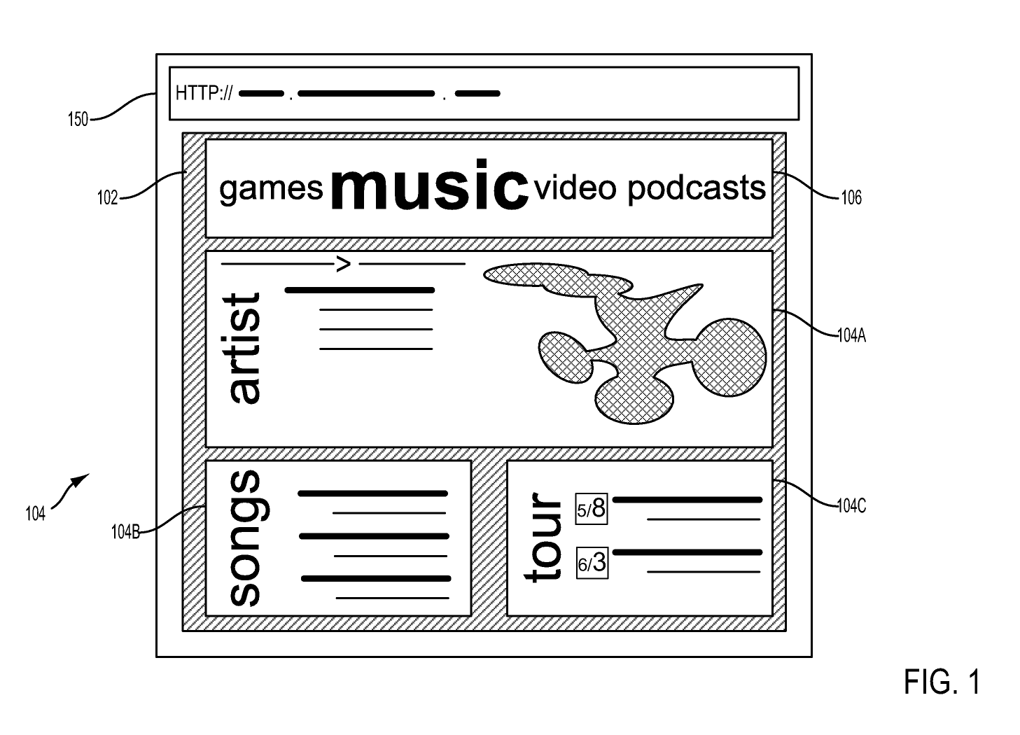

FIG. 1 shows an embodiment of a page 102 for viewing, such as a via web browser 150, on a computing device. As used herein, page 102 may refer to any grouped content visually presented by an electronic display. Examples of pages 102 include, but are not limited to, grouped content presented in a web page or in an electronic document, and grouped content provided via a client computing device user interface, such as a mobile device user interface, a gaming service interface, and a social media service interface. Thus, while the examples described herein relate to a webpage, it will be appreciated that page 102 may be any suitable visual display of grouped electronic content. Page 102 includes a plurality of rendered blocks 104 arranged on page 102 according to a page definition. The page definition defines the structure of page 102 and the position of each of rendered blocks 104 within that structure. Rendered blocks 104 present data to a user, forming the user's viewing experience of the data included in each rendered block. In the example shown in FIG. 1, page 102 presents an online media store web page for a recording artist. As structured by the page definition, page 102 includes three rendered blocks 104A-C and a header 106. Header 106 indicates that the page is a music page of the online media store. Rendered block 104A presents a view including the recording artist's name. Rendered block 104B presents a view of a song list. Rendered block 104C presents a view of a concert tour schedule for the artist.

Some approaches to generating page 102 include model-view-controller frameworks, which separate the graphical user interface from the business logic for exchanging information between a data model and the graphical user interface. However, because these approaches include manually crafted code for each page and because the code and markup may co-mingle on the page, such approaches may make it difficult to modify page appearance without breaking the page logic. For example, a user wishing to change the look of a page without changing the page logic may labor to search for and modify the relevant markup text.

Thus, a tiered approach for generating a page for viewing on a client computing device is provided. On a first tier, a lightweight page controller module configured to generate a pageview is provided. In response to receiving a request to display a page, the page controller identifies a page definition for the page. The page definition identifies a plurality of blocks for the page, each of which corresponds to a viewable portion of the page when the page is displayed. Thus, the user may change the content of the page, such as block location, without altering the underlying logic by editing the page definition.

In response to the page definition, and for each of the plurality of blocks, the page controller module initializes, on a second tier, a block controller module for each block. Each block controller module is assigned to manage, and contains all of the business logic for controlling, the rendering of a specific rendered block 104. Each block controller module issues data requests to receive values for parameters associated with the block. Example values include any suitable data type, such as strings, structured data, numbers, etc. Thus, in one scenario, a block controller may request a value for a song title and receive a value comprising the title of the song requested, metadata associated with the song title requested, and any other suitable information.

Each block controller module operates independent of, and indifferent to, any other block controller modules initialized by the page controller module. Further, view modules are provided for rendering the viewable portion of the page using the values received in response to data requests from the block controller module. Thus, editing the page definition manifests a changed content and layout of page 102, while the two tiers of controllers provide an approach to modularly controlling rendering of page 102.

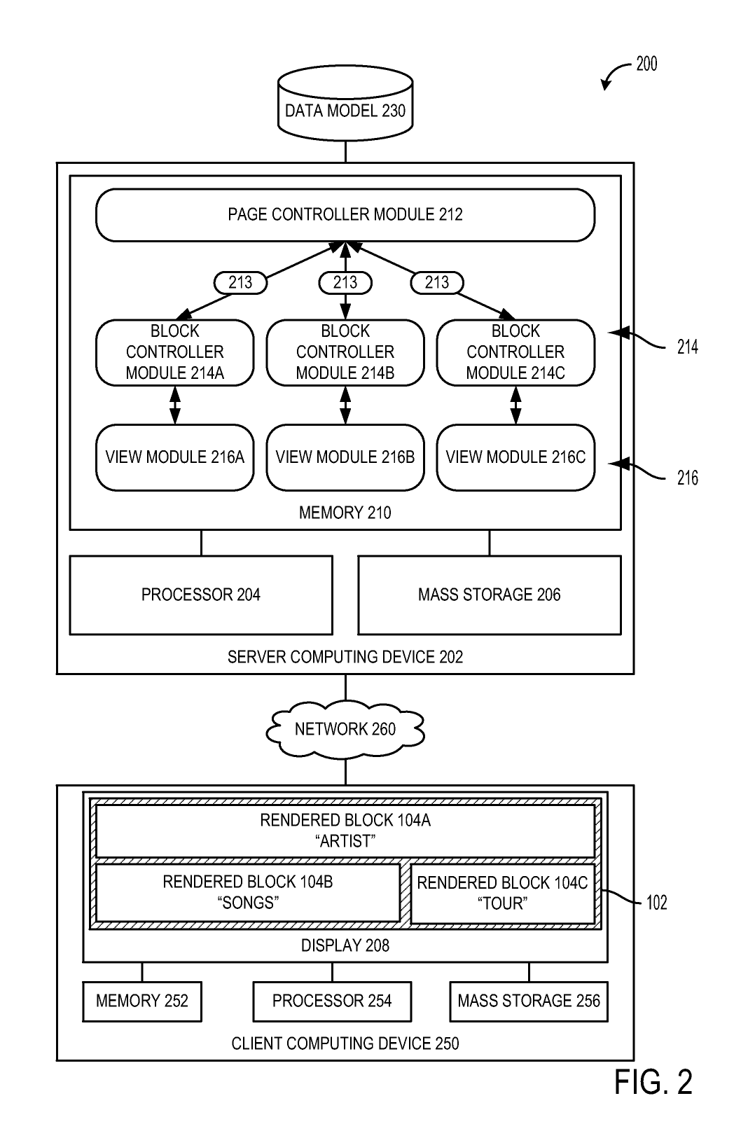

For example, FIG. 2 shows an embodiment of a pageview generating system 200 for generating pages 102 for viewing. In the example shown in FIG. 2, pages 102 are requested by a client computing device 250, rendered into markup by server computing device 202 in response the display request, and sent to client computing device 250 for display. Server computing device 202 includes mass storage 206, and memory 210 for storing instructions executable on processor 204. Example server computing devices 202 include, but are not limited to, retail servers, gaming servers, and social media servers. In some embodiments, server computing device 202 may be a server cloud.

Client computing device 250 includes mass storage 256, display 208, and memory 252 for storing instructions executable on processor 254. Example client computing devices 250 include, but are not limited to, a wireless computing device, a gaming console, and a mobile phone. As shown in FIG. 2, client computing device 250 is networked to server computing device 202 via network 260.

Pageview generating system 200 includes, at server computing device 202, a page controller module 212 for identifying and loading the page definition, and for initializing a plurality of block controller modules 214 according to the page definition. Block controller modules 214 register data requests with page controller module 212 according to block parameters 213 sent from page controller module 212 to block controller modules 214. Page controller module 212 then manages fulfillment of the data requests. Page controller module 212 requests, from data model 230, the data requests registered by block controller modules 214. In some embodiments, page controller module 212 may generate a schedule directing when data requests are made and what data will be requested. This may reduce redundancies in data requests and may avoid network traffic jams at data model 230. Each block controller module 214 passes the requested data received from data model 230 (via page controller module 212) to a complementary view module 216 for rendering on page 102.

View modules 216 generate markup code based on the requested data received from corresponding block controller modules 214. View modules 216 are instantiated by corresponding block controller modules 214. For example, a block controller module 214 may issue a render command including instructions to create and initialize view module 216 and instructions to create rendered block 104. Thus, in some embodiments, block controller modules 214 may instruct corresponding view modules 216 to render without being aware of the eventual appearance of rendered block 104, so that all markup code inserted onto page 102 is inserted by view modules 216.

Alternatively or additionally, in some embodiments, view modules 216 may comprise templates including a markup language, such as extensible markup language (XML) or hypertext markup language (HTML). Such templates may include placeholders to be substituted with specific data values passed from the corresponding block controller module 214. While the various modules described above are shown at server computing device 202, it will be appreciated that, in some embodiments, page controller module 212, block controller modules 214, and view modules 216 may be present on any suitable computing device. Additionally or alternatively, it will be appreciated that, in some embodiments, such modules may be distributed across two or more computing devices, such as in a server farm or server cloud environment.

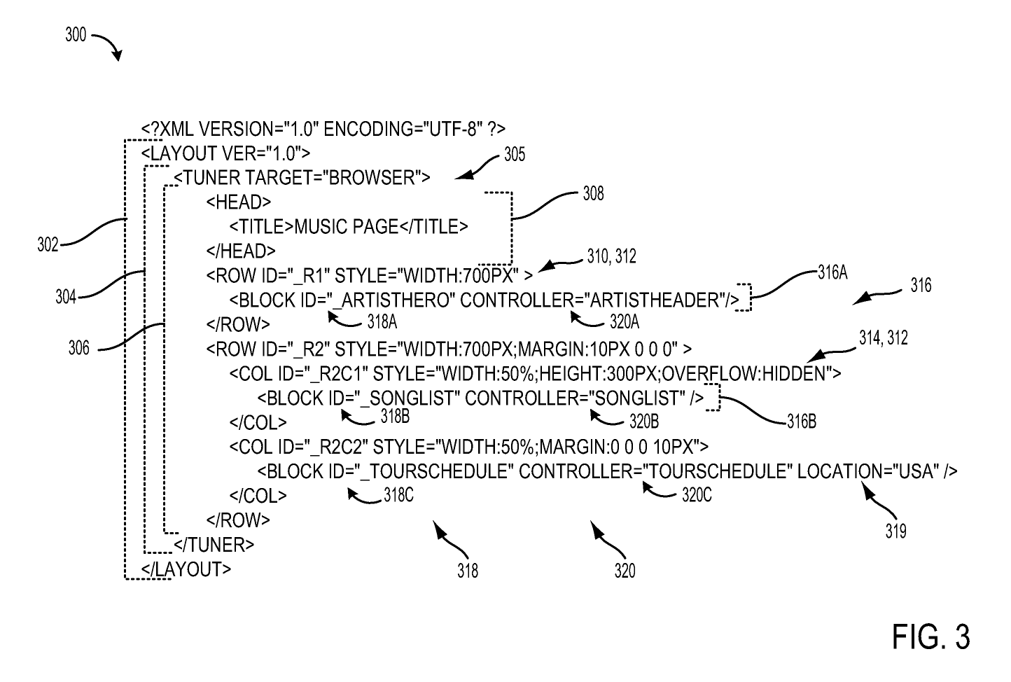

FIG. 3 shows an example page definition 300. Page definition 300 describes the structure of page 102 and the location of each rendered block 104 therein. In some embodiments, page definition 300 is stored in a page definition directory, the page definition directory comprising a plurality of page definitions 300. For example, the page definition directory may be located at server computing device 202, or the page definition directory may be located at another computing device networked to server computing device 202. In some embodiments, page definition 300 may be coded in a markup language. For example, in the embodiment shown in FIG. 3, page definition 300 is coded in an XML format.

As depicted in FIG. 3, page definition 300 includes layout element 302. Layout element 302 comprises the various constitutive elements of page definition 300. For example, layout element 302, as shown in FIG. 3, comprises a tuner element 304. Tuner element 304 includes a tuner tag 305, which defines a rendering target for page definition 300. This may allow page definition 300 to support a plurality of rendering targets. In the example shown in FIG. 3, tuner tag 305 indicates that page definition 300 is set for a browser, such as web browser 150. Other example tuner tags may include support for mobile devices and/or gaming consoles. While the embodiment depicted in FIG. 3 relates to tuner element 304 and tuner tag 305, it will be appreciated that, in some embodiments, other suitable elements and/or tags may be configured to indicate a rendering target.

As depicted in the embodiment of FIG. 3, a page definition element 306 may be nested within tuner element 304. In some embodiments, page definition element 306 may include a header element 308. Optional header element 308 comprises information and/or properties for defining a head section of page 102. For example, FIG. 3 includes a header element 308 identifying page 102 as a music page of an online media store. Header element 308 is presented as header 106 in the example shown in FIG. 1. In some embodiments, the information stored in header element 308 may be passed directly to page 102 by page controller module 212.

Page definition element 306 comprises a plurality of block elements 316. Block elements 316 describe each of the rendered blocks 104 that will be displayed on page 102. In some embodiments, page definition 300 may define the structure of the rendered blocks by reference to row and column location. This may provide flexibility for developers when creating layout schemes for pages. In the example shown in FIG. 3, row element 310 and column element 314 define the row and column locations for the various block elements 316 included in page definition element 306. Thus, the artist page described in page definition 300 of FIG. 3 includes a header section, a hero control on a first row, referenced by block element 316A, and a second row block elements 316B and 316C, each block appearing side-by-side on page 102 and taking up 50% of that row.

In some embodiments, optional style tags 312 may be included for one or more row elements 310 and/or column elements 314. Additionally, in some embodiments, attributes for each row and column location may be copied into tags inserted in page 102. Thus, for example, inline CSS style tag IDs and tag names may persist on page 102.

Block elements 316 comprise the specific block parameters 213 passed from page controller module 212 to the corresponding block controller module 214. Each block element 316 includes a block ID 318 for identifying and differentiating instances of a given block on a page. Further, each block element 316 includes a block controller module ID 320 for identifying each rendered block 104 and the block controller module 214 associated therewith.

In some embodiments, block element 316 may include one or more filtering parameters 319 specifying particular data to be obtained from data model 230. For example, a first instance of a tour schedule block may include a location filtering parameter configured to present tour dates for the USA (e.g., <BLOCK ID=“_TOURSCHEDULE” CONTROLLER=“TOURSCHEDULE” LOCATION=“USA”/>) and a second instance of the tour schedule block may include a location filtering parameter configured to present tour dates for Europe (e.g., <BLOCK ID=“_TOURSCHEDULEEU” CONTROLLER=“TOURSCHEDULE” LOCATION=“EUROPE”/>). While the example described herein relates to location filtering, it will be appreciated that any suitable filtering parameter 319 may be included in block element 316.

For example, as depicted in FIG. 3, block element 316A includes block ID 318A that identifies rendered block 104A as a hero control for a music page. Block element 316A also includes block controller module ID 320A, that, when read by page controller module 212, causes page controller module 212 to initialize and execute block controller module 214A. Block controller module 214A then gathers data relevant to the hero control for the artist from data model 230 via page controller module 212 and passes the data to view module 216A for rendering into rendered block 104A.

Similarly, FIG. 3 also depicts block element 316B, which includes a block ID 318B that identifies rendered block 104B as a song list. Block element 316B also includes block controller module ID 320B, that, when read by page controller module 212, causes page controller module 212 to initialize and execute block controller module 214B. Block controller module 214B then gathers data relevant to the song list for the artist from data model 230 via page controller 212 and passes the data to view module 216B for rendering into rendered block 104B.

Continuing with the example of FIG. 3, block element 316C includes a block ID 318C that identifies rendered block 104C as a concert tour schedule for the artist. Block element 316C also includes block controller module ID 320C, that, when read by page controller module 212, causes page controller module 212 to initialize and execute block controller module 214C. Block controller module 214C then gathers data relevant to the tour schedule for the artist from data model 230 via page controller 212 and passes the data to view module 216C for rendering into rendered block 104C. While the above example generally describes how the various modules of server computing device 202 might interact to display a webpage for an online media store, it will be appreciated that such modules may be employed in a method for displaying any suitable page 102. One example method is described in more detail below.

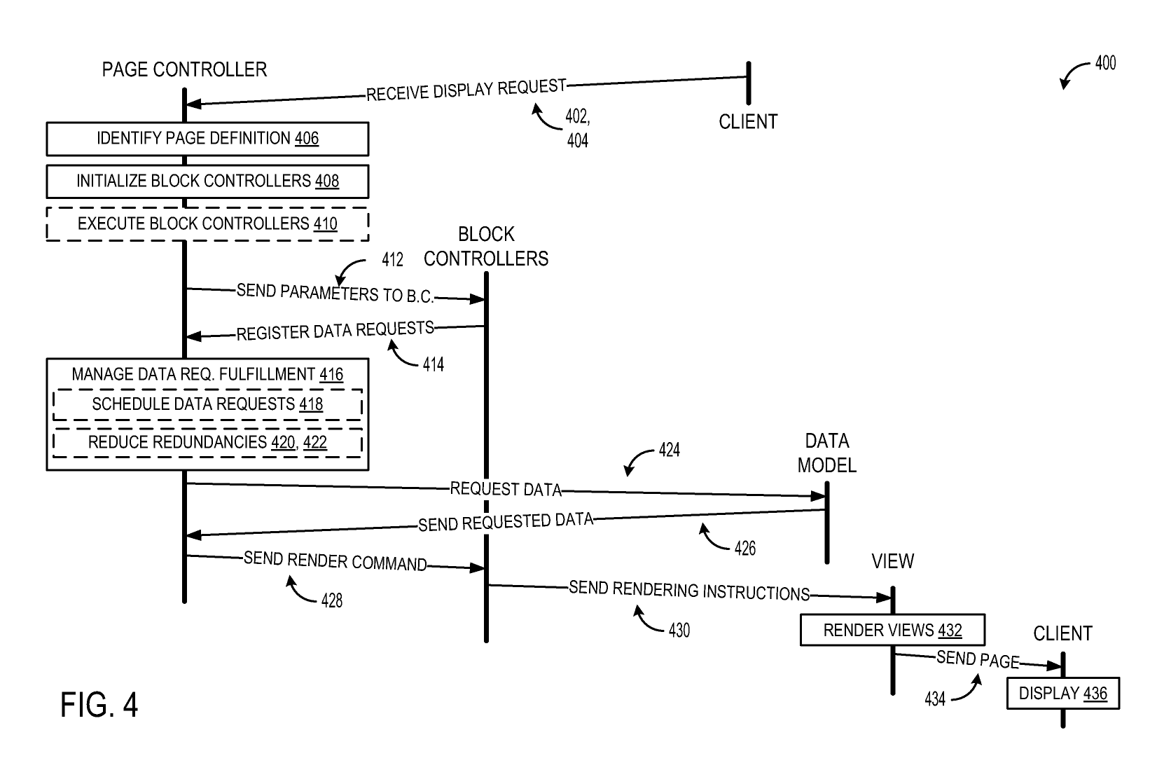

FIG. 4 shows a flow chart for an embodiment of a method 400 of generating a page for viewing on a computing device. In some embodiments, method 400 may be performed by the hardware and software described above, though it will be appreciated that method 400 may be performed by any suitable hardware and/or software.

At 402, method 400 comprises receiving a display request to display a page from a user at the page controller, such as a page controller of a server computing device. In the example shown in FIG. 4, the display request is received from a client computing device. The display request may include parameters that may be used to identify a page definition for the page. For example, a display request to display a page for a particular artist may include an artist ID. In some embodiments, 402 may include, at 404, identifying a page controller module associated with the page.

At 406, method 400 comprises, in response to the display request, at the page controller module, identifying a page definition associated with the page, where the page definition identifies a plurality of blocks for the page, each of which corresponds to a viewable portion of the page when the page is displayed. For example, the page controller may identify the page definition based on parameters included in the display request. In one scenario, a page definition for an artist page may be identified based on an artist ID included in the display request. In some embodiments, the page definition may be coded in a markup language format, such as an XML or an HTML format.

Additionally or alternatively, in some embodiments, the page definition may include a layout of the plurality of blocks on the page for defining a size and a location of one or more blocks on the page. Further, in some embodiments, the layout may define row and column locations of one or more of the plurality of blocks on the page. Further still, in some embodiments, the page definition may include a tuner tag identifying a rendering target for the page.

At 408, method 400 comprises, in response to the page definition, and for each of the plurality of blocks, initializing a block controller module for the block. Each block controller module is configured to modularly control rendering of a viewable portion of the requested page. Thus, each block controller module manages the behavior and the appearance of each rendered block on the page. In some embodiments, method 400 may include, at 410, at the page controller module, causing the execution of each block controller module in response to the page controller module identifying the page definition.

At 412, the page controller module sends block parameters for each of the block elements included in the page definition to the block controller module identified in the block element. Thus, the page controller module may pass block parameters included in the page definition to the relevant block controller modules. Example block parameters include, but are not limited to, block IDs, block controller module IDs, artist IDs, and filtering parameters. In one scenario, the page controller module may include, in a block parameter sent to a block controller module, an artist ID included in a display request received by the page controller module.

At 414, method 400 includes, at the block controller modules, registering data requests for the data model with the page controller module prior to the block controller modules obtaining the requested data from the data model. At 416, method 400 includes, at the page controller module, managing data request fulfillment.

In some embodiments, managing data request fulfillment may include, at 418, scheduling data requests at the page controller module such that the data requests are sent from the page controller module to a data model according to predetermined scheduling criteria. Thus, in some embodiments, predetermined scheduling criteria may specify that data requests are sent in parallel, in a particular sequence, or by combining non-overlapping data requests. This may accelerate page rendering by reducing data request serialization and/or by reducing network traffic to and from the data model.

Additionally or alternatively, in some embodiments, managing data request fulfillment may include, at 420, reducing redundancies in the data requests to be sent to the data model. This may accelerate page loading by reducing network traffic and/or by allowing the data model to fulfill the data requests in a more efficient manner. For example, reducing redundancies may include, at 422, for a plurality of block controller modules that have registered overlapping data requests, issuing a single, combined data request to the data model, receiving requested data from the data model in response to the single, combined data request, and sending select portions from the requested data to the block controller modules such that a particular block controller module receives select data according to the data request registered by the particular block controller module. Thus, in one scenario, a first block controller module may register a request for a list of songs that are playable and a second block controller module may register a request for a list of songs and play counts for those songs. The page controller module may send a single, combined data request for the list of songs, a list of playable songs, and play counts for the songs, to the data model. Upon receiving the requested data, the page controller may select a portion of the requested data, specifically the list of playable songs, for transmission to the first block controller module. The page controller may also select the list of songs and the play counts for those songs from the requested data for transmission to the second block controller module. While the above scenario addresses requests that are overlapping in scope, it will be appreciated that a similar approach may be used in scenarios having completely overlapping, or duplicative, requests.

At 424, method 400 includes issuing data requests, from the page controller module, to the data model, to receive values for parameters associated with the block. In some embodiments, the data requests may be issued by a data layer managed by the page controller module. At 426, method 400 includes sending values for the requested data from the data model to the page controller module.

At 428, method 400 includes sending a render command from the page controller module to the block controller module. In some embodiments, the render command may include a portion of the requested data. Alternatively or additionally, in some embodiments, a portion of the requested data may be sent from the page controller module to the block controller module before the render command is issued.

At 430, method 400 includes sending rendering instructions from the block controller modules to the view modules. The rendering instructions include instructions to create the view modules and/or to render the block. At 432, method 400 includes, at the view modules, rendering the viewable portion of the page using the values received in response to the requests registered from the block controller module. Thus, in some embodiments, rendering the viewable portion of the page may be performed by passing, from the block controller module to a view module, the values received in response to the data requests issued from the block controller module. In some embodiments, the view module may render the viewable portion of the page using a markup template. Method 400 further includes, at 434, sending the page for display. In some embodiments, sending the page at 434 may include sending markup for the page for display. At 436, method 400 includes displaying the page. In the example shown in FIG. 4, the page is sent to the client for display at the client, though it will be appreciated that the page may be sent to other suitable computing devices for display.

It will be appreciated that the computing devices and servers described herein may be suitable computing devices configured to execute the programs described herein. For example, the computing devices may be mainframe computers, personal computers, laptop computers, portable data assistants (PDAs), computer-enabled wireless telephones, networked computing devices, or other suitable computing devices, and may be connected to each other via computer networks, such as the Internet. These computing devices typically include a processor and associated volatile and non-volatile memory, as well as a mass storage device such as a hard drive. These computing devices are configured to execute programs stored in non-volatile memory using portions of volatile memory and the processor, to achieve the functionality described herein. The computing devices may be configured with user input devices such as keyboards, mice, and touch screens, for example, and further may be equipped with displays.

Further, as used herein, the terms “program” and “module” refer to software or firmware components that may be executed by, or utilized by, one or more computing devices described herein, and is meant to encompass individual or groups of executable files, data files, libraries, drivers, scripts, database records, etc. It will be appreciated that computer-readable storage media may be provided having program instructions stored thereon, which upon execution by a computing device, cause the computing device to execute the methods described above and cause operation of the systems described above. Computer-readable storage media may include a memory device such as random-access memory (RAM), read-only memory (ROM), a hard disk, a compact disc (CD), digital video disc (DVD), etc. Some or all of the programs and modules described herein may be software modules or hardware components, such as memory devices.

It may be appreciated that a “service” as used herein, may be an application program executable across multiple user sessions and available to other operating system components and applications. A service may run on a server responsive to a request from a client.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A computing device, comprising:
a page controller module configured to generate a page for viewing on a client computing device executed by a processor of the computing device using portions of memory and comprising instructions to:
receive a request to display a page;
in response to the request, identify a page definition associated with the page, where the page definition identifies a plurality of blocks for the page, each of which corresponds to a viewable portion of the page when the page is displayed; and
in response to the page definition, and for each of the plurality of blocks:
initialize a block controller module for the block;
issue data requests, from the block controller module, to receive values for parameters associated with the block; and
render the viewable portion of the page using the values received in response to the data requests.

2. The computing device of claim 1, further comprising instructions to, for each of the plurality of blocks, execute the block controller module in response to the page controller module identifying the page definition.

3. The computing device of claim 1, further comprising instructions for the block controller modules to register data requests with the page controller module and for the page controller module to request values for parameters associated with the block from a data model.

4. The computing device of claim 3, further comprising instructions to manage fulfillment of the data requests, at the page controller module, to reduce redundancies in the data requests.

5. A method of generating a page for viewing on a computing device, comprising:
receiving a display request to display a page at a page controller module;
in response to the display request, identifying a page definition associated with the page, where the page definition identifies a plurality of blocks for the page, each of which corresponds to a viewable portion of the page when the page is displayed; and
in response to the page definition, and for each of the plurality of blocks:
initializing a block controller module for the block;
issuing data requests, from the block controller module, to receive values for parameters associated with the block; and
rendering the viewable portion of the page using the values received in response to the data requests.

6. The method of claim 5, wherein the page definition includes a layout of the plurality of blocks on the page.

7. The method of claim 6, wherein the layout defines sizes and locations of the plurality of blocks.

8. The method of claim 6, wherein the layout defines row and column locations of the plurality of blocks.

9. The method of claim 5, wherein the page definition includes a tuner tag.

10. The method of claim 9, wherein the page definition includes a header element.

11. The method of claim 10, wherein the block controller modules register data requests with the page controller module prior to the block controller modules obtaining the requested data.

12. The method of claim 5, wherein, for each of the plurality of blocks, the page controller module causes execution of the block controller module in response to the page controller module identifying the page definition.

13. The method of claim 5, wherein the rendering of the viewable portion of the page is performed by passing, from the block controller module to a view module, the values received in response to the data requests issued from the block controller module.

14. The method of claim 13, wherein the view module renders the viewable portion of the page.

15. The method of claim 14, wherein the view module renders the viewable portion of the page using a markup template.

16. A method of generating a page for viewing on a computing device, comprising:
providing a plurality of block controller modules for a requested page, where each block controller module is configured to modularly control rendering of a viewable portion of the requested page;
for each of the plurality of block controller modules, registering data requests of the block controller module with a page controller module associated with the requested page; and
in response to said registering of the data requests, managing fulfillment of the data requests to each of the block controller modules.

17. The method of claim 16, wherein managing fulfillment is performed by the page controller module.

18. The method of claim 17, wherein managing fulfillment includes, once the data requests are registered at the page controller module, scheduling data requests at the page controller module such that the data requests are sent from the page controller module to a data model according to predetermined scheduling criteria.

19. The method of claim 16, wherein managing fulfillment includes reducing redundancies in the data requests to be sent to the data model.

20. The method of claim 19, wherein reducing redundancies includes, for a plurality of block controller modules that have registered overlapping data requests:
issuing a single, combined data request to the data model;
receiving requested data from the data model in response to the single, combined data request; and
sending select portions from the requested data to the block controller modules such that a particular block controller module receives select data according to the data request registered by the particular block controller module.
